(19) United States
(12) Patent Application Publication
(10) Pub. No.: US 2004/0154204 A1
(43) Pub. Date: Aug. 12, 2004

(54) Display holders for flat items

(75) Inventor: David Fu, Diamond Bar, CA (US)

Correspondence Address: DAVID WEISS, 12650 RIVERSIDE DRIVE, SUITE 100, NORTH HOLLYWOOD, CA, 91607-3442, US

(73) Assignee: ULTRA PRO L.P.

(21) Appl. No.: 10/662,632

(22) Filed: Sep. 15, 2003

Related U.S. Application Data
(60) Provisional application No. 60/447,154, filed on Feb. 12, 2003.

(51) Int. Cl. G09F 3/18

(52) U.S. Cl. 40/661.01; 40/661

(57) ABSTRACT

A protective display holder for a flat item, such as a collectible card or a photograph, comprising a substantially rigid base having a flat top surface and a recess from the flat surface for receiving the flat item; a substantially rigid cover having a flat bottom surface; and at least one magnetic member affixed to the base, and at least one magnetic member affixed to the cover and magnetically attracted to the at least one magnetic member affixed to the base for urging the bottom surface of the cover against the top surface of the base.

### CROSS-REFERENCE TO RELATED APPLICATION

This application claims the benefit of U.S. Provisional Patent Application No. 60/447,154 filed Feb. 12, 2003, which provisional application is incorporated herein by reference.

### BACKGROUND OF THE INVENTION

This invention relates to protective receptacles for holding and displaying flat items such as collectible cards and photographs, and more particularly to rigid protective holders for collectible cards and photographs that are easily assembled and disassembled.

The collection of cards depicting persons of common professional interest, such as sports figures, has been a common practice for many years. Sports cards suitable for collection generally contain a photographic reproduction of a sports person (for example, a baseball player) on one side and personal and professional information concerning such sports person on the card's reverse side. Sports cards are usually printed on cardboard of rectangular configuration and the cards are of common dimensions—i.e. the dimensions are uniform from card to card, generally 2½ inches in width by 3½ in height, and typically 14 to 18 mils in thickness and as thick as 120 mils.

Since the physical condition of collectible cards contributes significantly to their desirability and economic value, various devices have been employed by dealers and collectors for assisting in the preservation of the card while permitting such card to be displayed and examined. One type of such prior art card holders, commonly referred to as screw-down holders, comprises transparent rigid bottom and top plates or panels secured together by one or more screw fasteners, with the card or photograph held between flat surfaces of the two panels. The bottom panel or base includes a rectangular recess of depth slightly greater than the thickness of the card, and of length and width slighter greater than the length and width dimensions of the card, into which the card is placed before the top panel or cover is secured to the base. One such screw-down card holder, utilizing a single threaded fastener or screw and commonly referred to as a one-screw screw-down, is disclosed in U.S. Pat. No. 5,522,163 to Edward J. Neugebauer, the disclosure of which patent is incorporated herein by reference.

The card or photograph holder of the present invention is similar in some respects to the screw-down type of holder but eliminates the need for any screws, and may be assembled and disassembled without the use of a screwdriver or other tool.

### SUMMARY OF THE INVENTION

In accordance with an important aspect of the present invention, there is provided a protective display holder for a flat item having thickness and peripheral dimensions (such as a collectible card or a photograph), the holder comprising the combination of: a substantially rigid base having a flat top surface and a recess from the top surface for receiving the flat item (the recess having depth and peripheral dimensions equal to or preferably greater than the respective thickness and peripheral dimensions of the flat item); a substantially rigid cover having a flat bottom surface; and at least one magnetic member affixed to the base, and at least one magnetic member affixed to the cover and magnetically attracted to the at least one magnetic member affixed to the base for urging the bottom surface of the cover against the top surface of the base. The at least one magnetic member affixed to the base or to the cover comprises at least one magnet, and preferably the at least one magnet affixed to the base and the at least one magnet affixed to the cover are magnets. At least one of the cover and base is transparent.

According to another aspect of the present invention, the holder comprises the combination of: a substantially rigid base having a first edge and an opposite second edge, the base including a flat top surface and a recess from the top surface for receiving the flat item; a substantially rigid cover having a first edge and an opposite second edge, the cover including a flat bottom surface facing the base's top surface and recess, the cover's bottom surface releasably retained to the base's top surface in the vicinity of their first edges; a first magnetic member (preferably a magnet) affixed to the cover adjacent to its second edge, the first and second magnetic members magnetically attracted to each other for urging the bottom surface of the cover against the top surface of the base in the vicinity of their second edges.

According to one preferred embodiment of the present invention, there is provided a display holder for a flat item, the holder comprising the combination of: a substantially rigid base having a first edge and an opposite second edge, the base including a flat top surface and a recess from the flat top surface for receiving the flat item; a substantially rigid cover having a first edge and an opposite second edge, the cover including a flat bottom surface; a wall along the first edge of the base, the wall including at least one aperture; at least one projection along the first edge of the cover for being received by the at least one aperture in the wall along the first edge of the base; and a first magnetic member (preferably a magnet) affixed to the base adjacent to its second edge, and a second magnetic member (preferably a magnet) affixed to the cover adjacent to its second edge, the first and second magnetic members magnetically attracted to each other for urging the bottom surface of the cover against the top surface of the base in the vicinity of their second edges. The holder preferably includes a raised collar on one of the top and bottom surfaces about a corresponding one of the first and second magnetic members, and an indentation in the other of the top and bottom surfaces about a corresponding one of the first and second magnetic members for matingly receiving the collar. The configuration of each of the collar and the indentation is preferably an oval with its major diameter parallel to the second edge corresponding thereto.

According to second preferred embodiment of the present invention, a protective display holder for a flat item comprises the combination of: a substantially rigid base having a first edge and an opposite second edge, the base including a flat top surface and a recess from the top surface for receiving the flat item; a substantially rigid cover having a first edge and an opposite second edge, the cover including a flat bottom surface; a first magnetic member affixed to the base adjacent to its second edge, and a second magnetic member affixed to the cover adjacent to its second edge, the first and second magnetic members magnetically attracted to each other for urging the bottom surface of the cover against the top surface of the base in the vicinity of their second edges; and a third magnetic member affixed to the base adjacent to its first edge, and a fourth magnetic member affixed to the cover adjacent to its first edge, the third and fourth magnetic members magnetically attracted to each other for urging the bottom surface of the cover against the top surface of the base in the vicinity of their first edges. At least one (and preferably both) of the first and second magnetic members is a magnet, and at least one (and preferably both) of the third and fourth magnetic members is a magnet.

In a preferred configuration of this second preferred embodiment of the present invention, the second and fourth magnetic members each include an end portion projecting from the bottom surface of the cover, and the first and third magnetic members are each recessed from the top surface of the base; and the holder further includes indentations in the top surface respectively aligned with the first and third magnetic members for receiving the respective end portions of the second and fourth magnetic members.

The holder of yet another embodiment of the present invention is similar to the preferred configuration of the second preferred embodiment just described, except that the end of the second magnetic member is flush with the bottom surface of the cover, and the end of the first magnetic member is flush with the top surface of the base.

A fourth embodiment of the protective display holder for a flat item in accordance with the present invention is provided by the combination of: a substantially rigid base having a first edge and an opposite second edge, the base including a flat top surface and a recess from the top surface for receiving the flat item; a substantially rigid cover having a first edge and an opposite second edge, the cover including a flat bottom surface; a hinge pivotally securing the base and the cover along their first edges; and a first magnetic member affixed to the base adjacent to its second edge, and a second magnetic member affixed to the cover adjacent to its second edge, the first and second magnetic members magnetically attracted to each other for urging the bottom surface of the cover against the top surface of the base in the vicinity of their second edges. In this embodiment, the hinge may comprise a flexible tape affixed to the first edges of the base and the cover.

### BRIEF DESCRIPTION OF THE DRAWINGS

The novel features believed to be characteristic of the invention, together with further advantages thereof, will be better understood from the following description considered in connection with the accompanying drawings in which preferred embodiments of the present invention are illustrated by way of example. It is to be expressly understood, however, that the drawings are for the purpose of illustration and description only and are not intended as a definition of the limits of the invention.

FIG. 1 is a generally top perspective view of a first preferred embodiment of a protective display holder for a flat item in accordance with the present invention, specifically a card holder, shown disassembled or in exploded arrangement;

FIG. 2 is a generally top perspective view of the holder of FIG. 1, shown assembled but without containing the flat item or card indicated in FIG. 1;

FIG. 3 is a top plan view of the base member shown in FIG. 1;

FIG. 4 is an elevation view of a first transverse edge of the base member of FIG. 3;

FIG. 5 is a cross-sectional view of the base member of FIG. 3, taken along the line 5-5 of FIG. 3 viewed in the direction of the appended arrows;

FIG. 6 is an enlarged fragment of the cross-sectioned base member shown in FIG. 5 within the area bounded by the dashed line 6;

FIG. 7 is a bottom plan view of the cover member shown in FIG. 1;

FIG. 8 is a cross-sectional view of the cover member of FIG. 7, taken along the line 8-8 of FIG. 7 viewed in the direction of the appended arrows;

FIG. 9 is an enlarged fragment of the cross-sectioned cover member shown in FIG. 8 within the area bounded by the dashed line 9;

FIG. 10 is an enlarged fragmented cross-sectional view of the assembled holder of FIG. 2, taken along the line 10-10 of FIG. 2 viewed in the direction of the appended arrows;

FIG. 11 is an enlarged cross-sectional view of a fragment of a portion of the assembled holder of FIG. 2, taken along the line 11-11 of FIG. 2 viewed in the direction of the appended arrows;

FIG. 12 is an alternative configuration of the fragment shown at the right hand portion of FIG. 10;

FIG. 13 is a perspective view of an example of the holder according to the present invention, in combination with a support for supporting the holder in an upright position;

FIG. 14 is a generally top perspective view of a second preferred embodiment of a protective display holder for a flat item in accordance with the present invention, specifically a card holder, shown disassembled or in exploded arrangement;

FIG. 15 is a generally top perspective view of the holder of FIG. 14, shown assembled but without containing the flat item or card indicated in FIG. 14;

FIG. 16 is a top plan view of the base member shown in FIG. 14;

FIG. 17 is a cross-sectional view of the base member of FIG. 16, taken along the line 17-17 of FIG. 16 viewed in the direction of the appended arrows;

FIG. 18 is a bottom plan view of a first panel of an alternative construction of the base member shown in FIG. 16;

FIG. 19 is a cross-sectional view of the panel of FIG. 18, taken along the line 19-19 of FIG. 18 viewed in the direction of the appended arrows;

FIG. 20 is a top plan view of a second panel of the alternative construction of the base member shown in FIG. 16;

FIG. 21 is a cross-sectional view of the panel of FIG. 20, taken along the line 21-21 of FIG. 20 viewed in the direction of the appended arrows;

FIG. 22 is a cross-sectional view of the base member alternative construction of FIG. 16, constructed by combining the first and second panels of FIGS. 18-21;

FIG. 23 is a bottom plan view of the cover member shown in FIG. 14;

FIG. 24 is a cross-section view of the cover member of FIG. 23, taken along the line 24-24 of FIG. 23 viewed in the direction of the appended arrows;

FIG. 25 is a cross-sectional view of the assembled holder of FIG. 15, taken along the line 25-25 of FIG. 15 viewed in the direction of the appended arrows;

FIG. 26 is a cross-sectional view of a third embodiment of the holder according to the present invention; and

FIG. 27 is a cross-sectional view of a fourth embodiment of the holder according to the present invention.

### DETAILED DESCRIPTION OF THE PREFERRED EMBODIMENTS

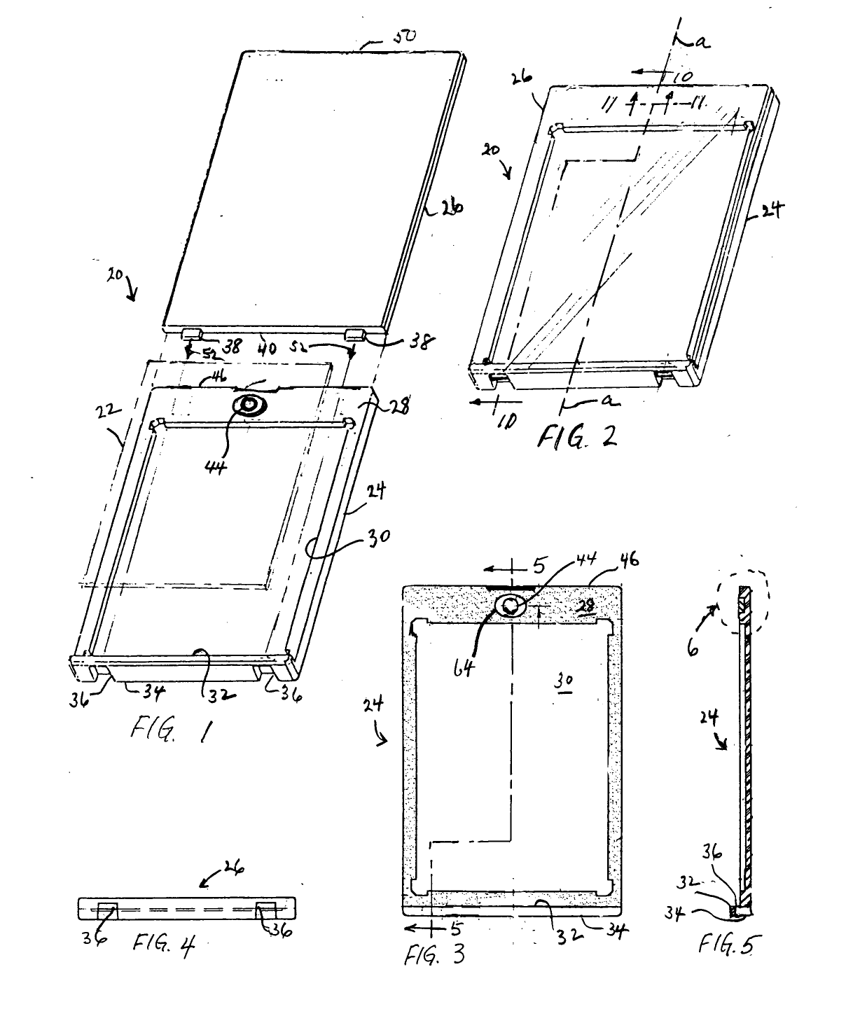

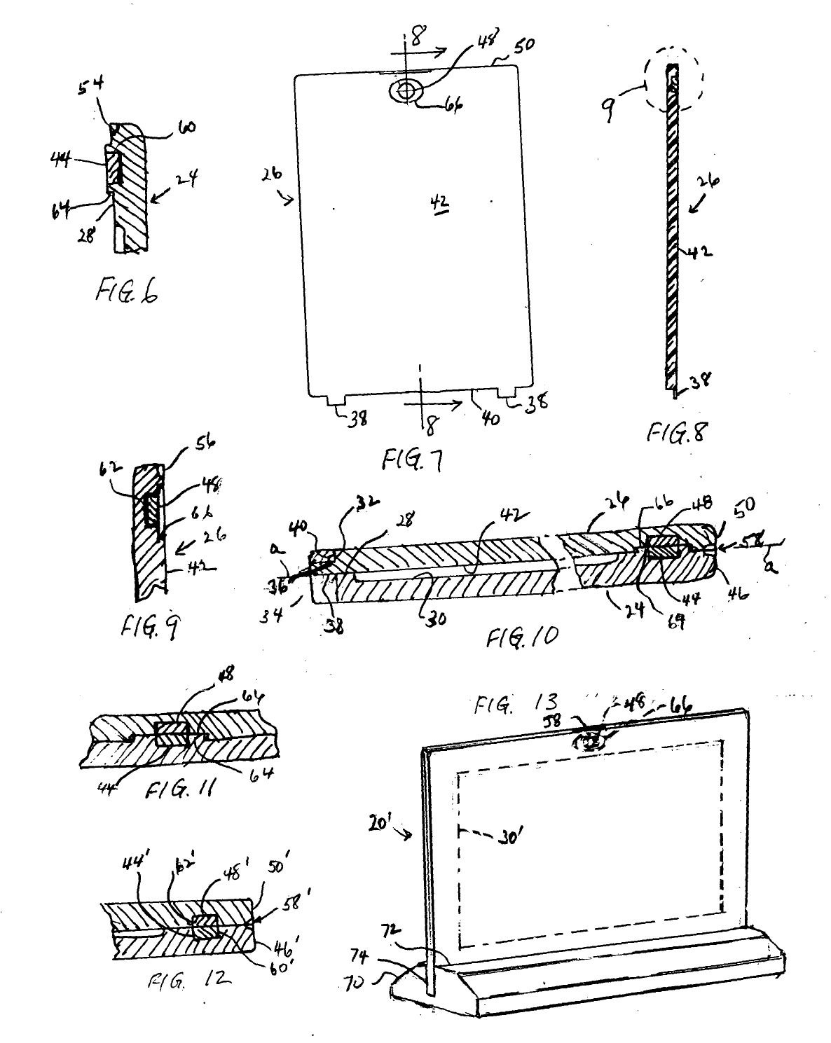

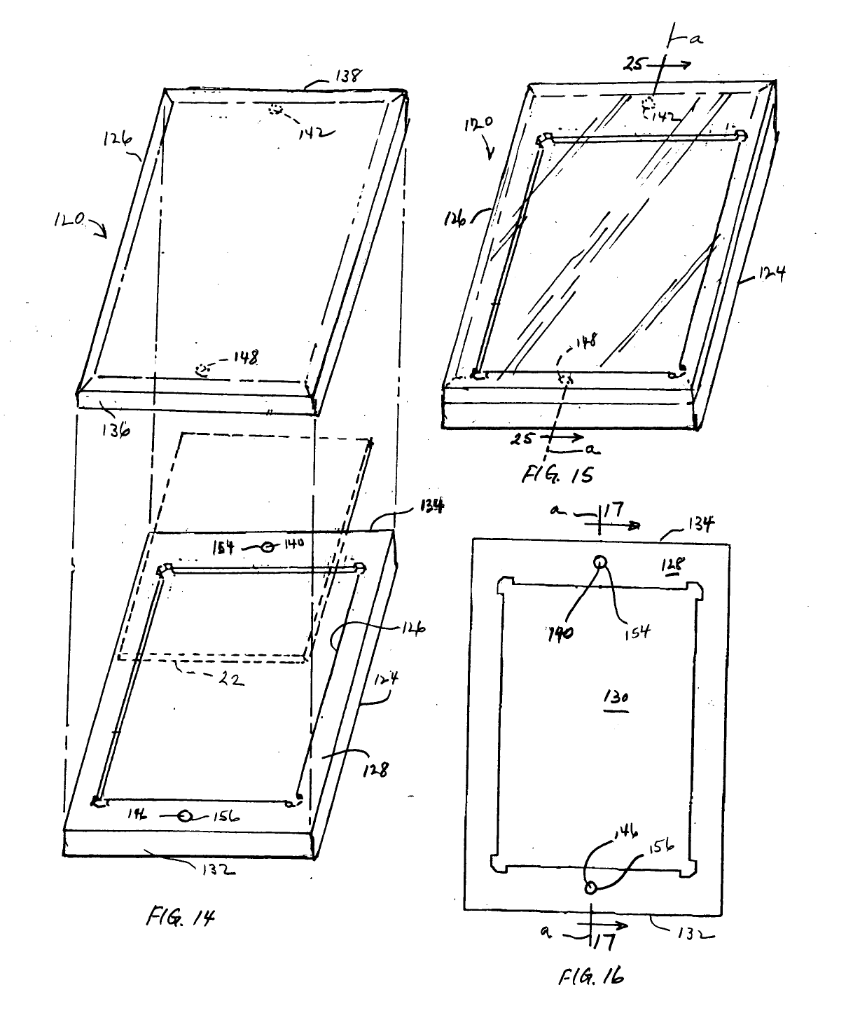

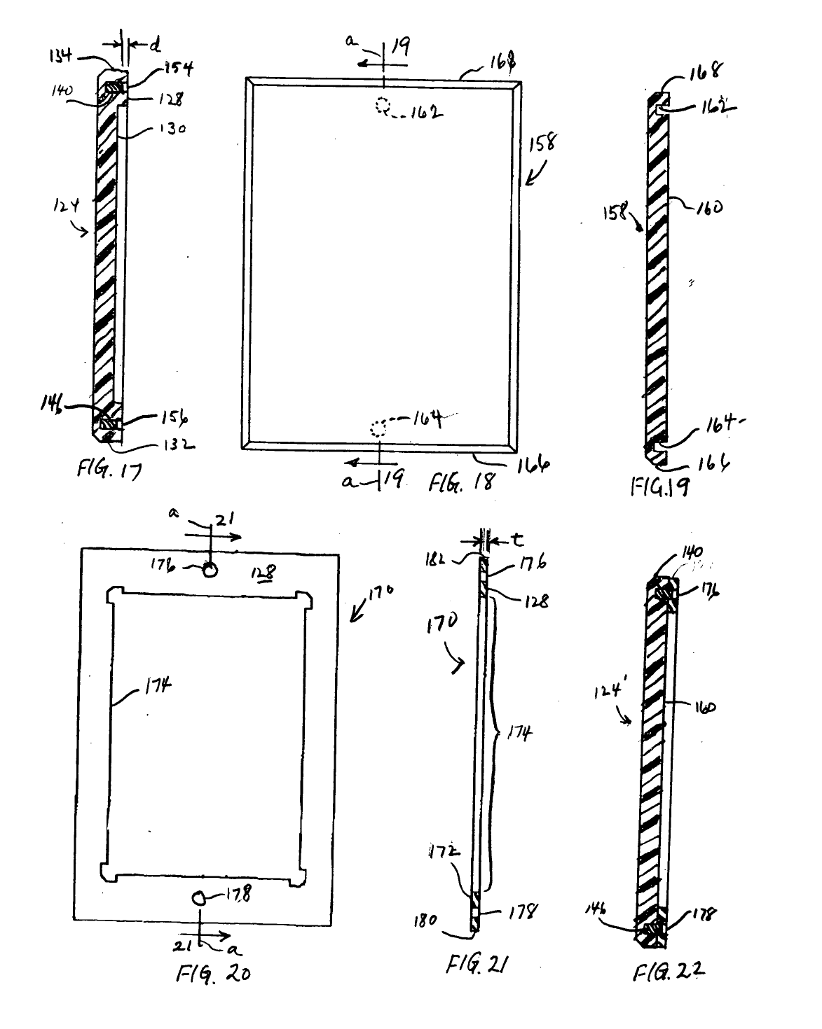

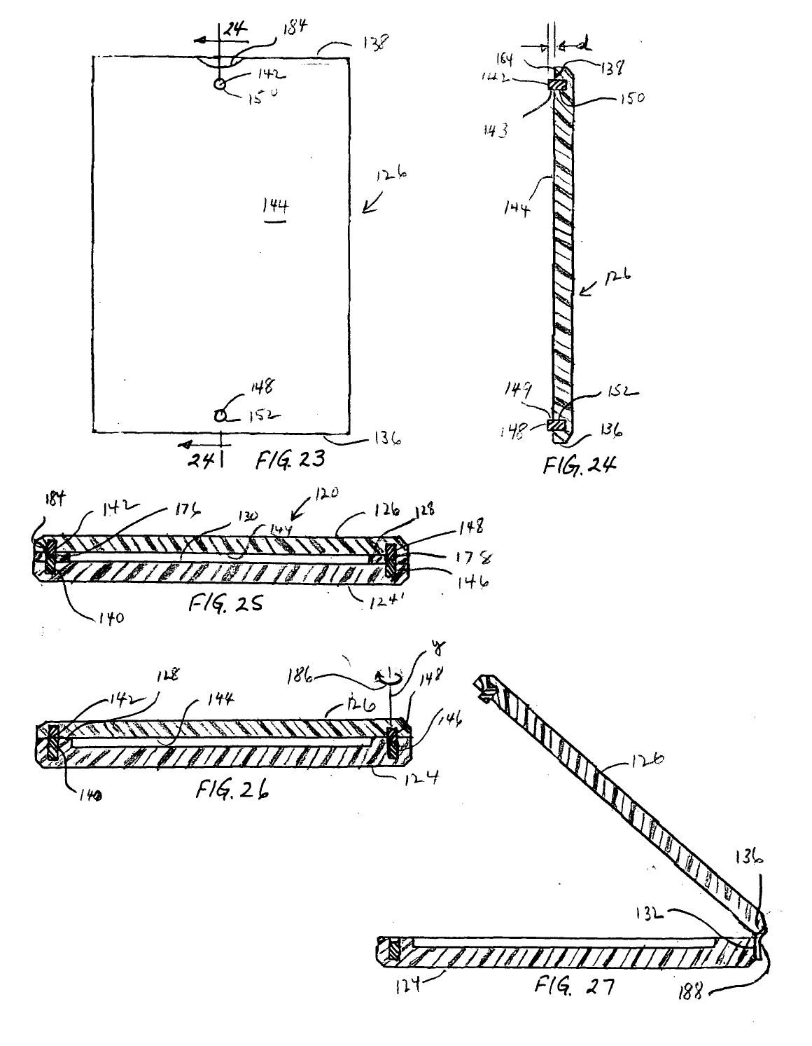

Turning to FIGS. 1 and 2, there is shown a first preferred embodiment of a receptacle or holder 20 for holding a flat item such as a photograph or a collectible card 22 shown in phantom in FIG. 1. The holder 20 includes a substantially rigid base panel member 24 and a substantially rigid cover panel member 26, the base 24 including a top surface 28 and a substantially rectangular recess 30 from the top surface 28. The recess 30 has depth, width and length dimensions equal to or preferably slightly greater than those of the photograph or card 22, for accommodating the card 22 therein and between the base 24 and the cover 26 in conventional manner when the holder 20 is in its assembled condition. The base 24 and cover 26 are preferably of substantially flat, rectangular configuration, preferably of a plastic material such as polystyrene or acrylic and manufactured by well known fabrication techniques such as injection molding and/or machining. Both the base 24 and the cover 26 are preferably transparent, at least in the area of the recess 30, so that both printed sides of the held card 22 may be viewed, although one or the other of the base 24 or cover 26 may be opaque if desired, for example for holding a photograph or a card having printing on one side only.

In one example of a holder 20 for cards nominally 2.5 inches by 3.5 inches, the recess 30 had a depth of 0.035 inch, an inside width dimension of about 2.530 inches and an inside length dimension of about 3.520 inches. In its assembled condition, this holder example had outside dimensions of approximately 4.331 inches in length, 2.875 inches in width, and approximately 0.275 inch in thickness.

Considering FIGS. 3-11 in addition to FIGS. 1 and 2, an upstanding wall 32 along a first transverse edge 34 (i.e., transverse to the holder's longitudinal axis a-a preferably along the holder's long or length dimension, although the axis a-a may instead be along the holder's short or width dimension) of the base 24 includes at least one but preferably two slots or apertures 36 longitudinally therethrough. The wall 32 extends above the base's top surface 28 by a distance preferably equal to the thickness of the cover 26. The cover 26 includes at least one and preferably two longitudinally extending projections or flanges 38 along a first transverse edge 40 for being received respectively by the apertures 36, preferably until the cover transverse edge 40 contacts the base wall 32, when the smooth bottom surface 42 of the cover 26 engages the smooth top surface 28 of the base 24 when assembling the cover 26 to the base 24.

This preferred embodiment of the holder 20 includes a first magnet 44 fixedly secured in the base 24 adjacent to a second transverse edge 46 of the base 24 opposite the base's first transverse edge 34, and a second magnet 48 fixedly secured in the cover 26 adjacent a second transverse edge 50 of the cover 26 opposite the cover's first transverse edge 40. The magnets 44, 48 are respectively situated in the base 24 and the cover 26 preferably centered between their lateral edges, and such that, when the holder 20 is in its assembled condition as shown in FIG. 2, the magnets 44, 48 are in registration with opposite magnetic poles facing and preferably contacting each other. Accordingly, the magnets 44, 48 are magnetically attracted to each other, causing the cover's bottom surface 42 in the vicinity of the cover's second transverse edge 50 to be held against the base's top surface 28 in the vicinity of the base's second transverse edge 46.

The magnets 44, 48 may be in any convenient configuration including, for example, bars, polygons, wafers or cylinders. In one example, each of the magnets 44, 48 comprised circular cylinder or disk 5 millimeters in diameter by 1.5 millimeters in thickness. The magnets should be of sufficient magnetic strength to hold the cover 26 and base 24 together but not so great as to prevent the magnets from being urged apart when disassembling the holder 20 as discussed below. Magnets of this type are well known, such as those used in common practice for holding light flat items to refrigerator doors. A magnetic member other than a magnet, i.e. a magnetic member of a material (such as iron or steel) capable of being attracted by a magnet, may be substituted for one of the magnets 44, 48.

As best shown in FIGS. 6 and 9, the base magnet 44 may be fixedly secured in the base 24 by being press fit into a cavity 60 such as a blind bore opening to the base's top surface 28. Similarly, the cover magnet 48 may be fixedly secured in the cover 26 by being press fit into a cavity 62 such as blind bore opening to the cover's bottom surface 42. Of course, other fixative means and methods are possible, such as the use of adhesive materials or welding techniques.

In this preferred embodiment, one of the facing surfaces 28, 42 is provided with at least one protrusion in the vicinity of its second transverse edge, and the other surface is provided with at least one recess or indentation for respectively receiving the protrusions. In this preferred embodiment, the base's top surface 28 includes a raised collar 64 about the base magnet 44 (FIGS. 3 and 6) and the cover's bottom surface 42 includes a recess or indentation 66 (FIGS. 7 and 9) for matingly receiving the collar 64 during assembly of the holder 20 when the magnets 44, 48 are placed in registration and preferably contacting one another (FIG. 10). Alternatively, the cover 26 may be configured with the collar 64 about the cover magnet 48 and the base 24 may be configured with the mating indentation 66.

A preferred example each of the collar 64 and indentation 66 is oval in configuration such as with the minor diameter being along the longitudinal axis a-a (FIGS. 3, 7 and 10) and the major diameter being transverse to the axis a-a (i.e. parallel to the transverse edges 46, 50, see FIGS. 3, 7 and 11), which configuration provides an advantage over a circular configuration in that the tendency for rotation of the base 24 and cover 26 about the circular magnets is discouraged. Other collar/indentation configurations having such advantage (such as polygons), as well as a circular configuration, are however included within the scope of the invention.

The holder 20 may be assembled by sliding the cover 26 upon the base 24 (with the cover's bottom surface 42 facing the base's top surface 28) in a longitudinal direction (i.e., sliding the cover 26 over the base 24 downwardly as viewed in the drawing of FIG. 1 in the direction of the arrows 52, or to the left as viewed in the drawing of FIG. 10) such that the cover flanges 38 are received by the base apertures 36. Alternatively, the cover flanges 38 may be inserted in the base apertures 36 with the cover 26 disposed at an acute angle with respect to the base 24, whereupon the cover 26 may be pivoted from its first transverse edge 40 about the base's wall 32, toward the base 24 until the cover's bottom surface 42 contacts the base's top surface 28. In either case, the magnets 44, 48 will come into registration and be magnetically attracted to one another, with the collar 64 being matingly received by the indentation 66, resulting in the bottom surface 42 of the cover 26 being held to the top surface 28 of the base 24 in the vicinity of their second transverse edges 46, 50.

It may be appreciated that, when so assembled, the cover 26 is restrained from further longitudinal movement in the direction of the arrows 52 with respect to the base 24 by the cover's first transverse edge 40 being in contact with the base's wall 32, as well as the base 24 and cover 26 being restrained from being separated perpendicularly from each other by the magnetic attraction of the magnets 44, 48. Further, the width of the cover flanges 38 and of the base apertures 36 are such that the flanges 38 just fit into the apertures 36, restraining the cover 26 and base 24 from relative transverse movement in the vicinity of their first transverse edges 40, 34. The mated collar 64 and recess 66 combination, together with the magnetic attraction of the magnets 44, 48, restrains transverse movement and longitudinal disassembling movement of the cover 26 relative to the base 24 (i.e., opposite the direction of the arrows 52 in FIG. 1). The cover 26 and base 24 are thereby maintained in assembled condition.

The base 24 preferably includes a notch 54 along the base's second transverse edge 46 and adjacent the base magnet 44, and the cover 26 preferably includes a notch along the cover's second transverse edge 50 and adjacent the cover magnet 48. When the cover 26 and the base 24 are in their assembled condition, the notches 54, 56 are in registration to form a channel or groove 58 for facilitating separation of the cover 26 from the base 24 so that the holder 20 may be disassembled. For example, a user may insert the edge of a fingernail from each hand into the groove 58 while resting the base's first transverse edge 34 against a support, urging the second transverse edges 46, 50 apart until the magnetic attraction of the magnets 44, 48 is overcome, pivoting the cover 26 from its first transverse edge 40 about the base's wall 32 (away from the base), and then withdrawing the cover 26 and its flanges 38 from the base 24 and its apertures 36. Alternatively, the force for overcoming the magnetic attraction to separate the second transverse edges may be applied by inserting the edge of a coin in the groove 58 and twisting such coin about the longitudinal axis a-a.

Although the mating collar 64 and recess 66 combination of the preferred holder embodiment (FIG. 10) provides increased resistance to relative transverse and longitudinal movement of the cover 26 and base 24, adequate resistance against such movements may be provided by the magnetic attraction of the magnets 44, 48 alone, i.e. without the presence of the mating collar 64 and recess 66 combination as shown in FIG. 12 where primed reference numerals identify components corresponding to unprimed reference numerals in FIG. 10.

FIG. 13 shows an alternative configuration 20′ of the holder 20, in which the magnets and mating collar/indentation (represented by magnet 48 and indentation 66 shown in phantom) are situated adjacent to one of the holder's long edges while the cover flange and base aperture combinations are situated along the holder's other long edge, the recess 30′ for containing a flat item (e.g. a photograph) shown in phantom. FIG. 13 further illustrates the holder of the present invention adaptable to being retained in an upright position by a support, such as a support 70 including a longitudinal groove 72 for supportingly receiving an edge portion 74 of the holder. Such arrangement is of particular usefulness for displaying a photograph in the holder, and is convenient for easily changing displayed photographs from time to time. The dimensions of the recess 30′ are slightly larger than the photograph to be contained therein; such photographs may be of standard dimensions (such as 4 inches by 6 inches, 5 inches by 7 inches, 8 inches by 10 inches) or of custom dimensions.

FIGS. 14 and 15 show a second preferred embodiment of a receptacle or holder 120 for holding a flat item such as the photograph or collectible card 22 shown in phantom in FIG. 14. The holder 120 includes a substantially rigid base panel member 124 and a substantially rigid cover panel member 126, the base 124 including a top surface 128 and a substantially rectangular recess 130 from the top surface 128. The recess 130 has depth, width and length dimensions slightly greater than those of the photograph or card 22, for accommodating the card 22 therein and between the base 124 and the cover 126 in conventional manner when the holder 120 is in its assembled condition. The base 124 and cover 126 are preferably of substantially flat, rectangular configuration, preferably of a plastic material such as acrylic or polystyrene and manufactured by well-known fabrication techniques such as machining and/or injection molding. Both the base 124 and the cover 126 are preferably transparent, at least in the area of the recess 130, so that both printed sides of the held card 22 may be viewed, although one or the other of the base 124 or cover 126 may be opaque if desired.

Considering FIGS. 16-25 in addition to FIGS. 14 and 15, the base 124 includes a first transverse edge 132 (i.e., transverse to the holder's longitudinal axis a-a preferably along the holder's long or length dimension, although the axis a-a may instead be along the holder's short or width dimension) and an opposite second transverse edge 134, while the cover 126 includes a first transverse edge 136 and an opposite second transverse edge 138. The peripheral dimensions (i.e. width and length) of the base 124 are preferably substantially the same as the peripheral dimensions of the cover 126.

A first magnetic member 140 is fixedly secured in the base 124 adjacent to the base's second transverse edge 134, and a second magnetic member 142 is fixedly secured in the cover 126 adjacent to the cover's second transverse edge 138. At least one (and preferably both) of the magnetic members 140, 142 is a magnet, so that the magnetic members 140, 142 are magnetically attracted to each other when proximately positioned. The magnets 140, 142 are respectively situated in the base 124 and the cover 126 preferably centered between their lateral edges (i.e., the edges parallel to the longitudinal axis a-a), and such that, when the holder 120 is in its assembled condition as shown in FIG. 15, the magnets 140, 142 are in registration with opposite magnetic poles facing and preferably contacting each other. Accordingly, the first and second magnets 140, 142, being magnetically attracted to each other, cause the cover's smooth bottom surface 144 in the vicinity of the cover's second transverse edge 138 to be held or urged against the base's smooth top surface 128 in the vicinity of the base's second transverse edge 134.

Similarly, a third magnetic member 146 is fixedly secured to the base 124 adjacent to the base's first transverse edge 132, and a fourth magnetic member 148 is fixedly secured in the cover 126 adjacent to the cover's first transverse edge 136. At least one (and preferably both) of the magnetic members 146, 148 is a magnet, so that the magnetic members 146, 148 are magnetically attracted to each other when proximately positioned. The magnets 146, 148 are respectively situated in the base 124 and the cover 126 preferably centered between their lateral edges, and such that, when the holder 120 is in its assembled condition as shown in FIG. 15, the magnets 146, 148 are in registration with opposite magnetic poles facing and preferably contacting each other. Accordingly, the third and fourth magnets 146, 148, being magnetically attracted to each other, cause the cover's smooth bottom surface 144 in the vicinity of the cover's first transverse edge 136 to be held or urged against the base's smooth top surface 128 in the vicinity of the base's first transverse edge 132.

The magnets 140, 142, 146, 148 preferably comprise circular cylinders (for example four millimeters in diameter), and should be of sufficient magnetic strength to hold the cover 126 and base 124 together but not so great as to prevent the magnets from being urged apart or separated when disassembling the holder 120 as discussed below.

In this preferred holder embodiment 120, the second and fourth magnets 142, 148 protrude from the bottom surface 144 of the cover 126 by a distance d (see FIG. 24), the magnets 142, 148 being fixedly secured in the cover 126 such as by being press fit into respective blind bores 150, 152 opening to the cover's bottom surface 144 (although other fixative techniques are possible). The first and third magnets 140, 146 are fixedly secured in the base 124 such as by being press fit into respective blind bores 154, 156 opening to the base's top surface 128 (see FIG. 17), and the exposed end surface of each of the magnets 140, 146 are recessed into their respective bores 154, 156 preferably by the distance d from the base's flat top surface 128. The bores 154, 156 along the distance d comprise an indentation in the base's top surface 128 aligned and communicating with the recessed end surfaces of the magnets 140, 146. The diameter of the bores 154, 156 is slightly greater than the diameter of the protruding end portions 143, 149 of the second and fourth magnets 142, 148, for matingly receiving such protruding end portions 143, 149 during assembly of the holder 120 when the cover 126 is placed to the base 124 with the cover magnets 142, 148 in registration with and preferably contacting the respective ends of the magnets 140, 146 recessed in the base 124.

In an alternative configuration, the base 124 may be configured with the protruding magnets while the cover 126 may be configured with the recessed magnets. In yet another alternative configuration, the base 124 may be configured with one protruding magnet and one recessed magnet, while the cover 126 may be configured with one recessed magnet and one protruding magnet.

One manner of fabricating the base 124, and the resulting base configuration 124′, is illustrated in FIGS. 18-22. A substantially rigid rectangular first base panel 158 having a flat surface 160 includes blind bores 162, 164 centrally positioned adjacent to respective transverse edges 168, 166, the bores 162, 164 opening to the flat surface 160 (FIGS. 18 and 19). The diameter of the bores 162, 164 are preferably such that the base magnets 140, 146 may be press fit into such bores.

A substantially rigid rectangular second base panel 170 has thickness t measured between parallel flat surfaces 128, 172 (FIGS. 20 and 21), the thickness t being equal to the depth of the recess 130 of the base member 124 (i.e., the thickness t is equal to or greater than the thickness of the flat item or card 22). The second base panel 170 includes an opening 174 therethrough of peripheral dimensions the same as those of the recess 130 of the base 124 (i.e., the peripheral dimensions of the opening 174 are equal to or greater than the peripheral dimensions of the flat item or collectible card 22). The opening 174 may be centrally situated within the outer or peripheral dimensions of the second base panel 170.

The second base panel 170 includes apertures or bores 176, 178 therethrough, centrally positioned adjacent to the transverse edges 180, 182 of the second panel 170, which bores 176, 178 are respectively concentric with the bores 162, 164 when the two panels 158, 170 are fixedly secured together as shown in FIG. 22, with the flat surface 172 of the second panel 170 contacting the flat surface 160 of the first base panel 158, for example by use of a suitable adhesive. The diameter of the bores 176, 178 is preferably slightly greater than the diameter of the cover magnets 142, 148, so as to permit the protruding end portions 143, 149 of the cover magnets 142, 148 to be slip-fit into the bores 176, 178. In a preferred example, the thickness t of the second base panel was approximately two millimeters, and the end portions of the cover magnets 142, 148 protruded from the cover's bottom surface 144 by approximately one millimeter. In this example, the peripheral dimensions of the opening 174 were approximately 2.520 inches in width and 3.520 inches in length, the outer peripheral dimensions of each base panel and the cover were approximately 3⅜ inches in width and 4⅝ inches in length, and the thickness of the first base panel and the cover was each approximately 3/16 inch.

When the two base panels 158, 170 are fixedly secured together and the magnets 140, 146 are secured in their respective bores, there results the alternative configuration 124′ of the base similar to the base 124 except as discussed above. In addition, the second base panel 170 may be opaque, and/or a color, for providing an ornamental or distinctive frame about the recess 130.

The holder 120 may be assembled by placing the cover 126 upon the base 124 or 124′, with the protruding end portions 143, 149 of the cover magnets 142, 148 received by the respective bores 176, 178 (as shown in FIG. 25) and with the cover's flat bottom surface 144 contacting the base's flat top surface 128. The magnet 148 and the magnet 146 are magnetically attracted to each other; preferably, the exposed ends of each of these magnets are contacting one another. Similarly, the magnets 142 and 140 are magnetically attracted to each other; preferably, the exposed ends of these magnets are contacting one another. Accordingly, the cover's smooth bottom surface 144 in the vicinity of its transverse edges is held against the base's smooth top surface 128 in the vicinity of its transverse edges. Although the alternative base configuration 124′ is shown in FIG. 25, it may be appreciated that the base configuration 124 may be substituted therefor.

When so assembled, the projection of the two cover magnets 142, 148 into their corresponding base bores 176, 178 (or 154, 156) restrains the cover 126 and base 124′ (or 124) from relative twisting movement, or relative lateral or transverse movement.

The cover 124 preferably includes a finger notch 184, for facilitating disassembly of the holder 120. When the cover 126 and the base 124′ (or 124) are in their assembled condition, the notch 184 forms a channel or groove between the cover and the base. To disassemble the holder 120, a user may insert the tip of a finger for pulling apart the cover from the base, or the user may insert the edge of a coin in the groove and twist such coin about the longitudinal axis a-a for separating the cover from the base.

The third embodiment of the holder according to the present invention, shown in FIG. 26, is similar to the holder 120 except that the exposed end of one of the cover magnets (e.g. the cover magnet 142) is substantially flush with the cover's bottom surface 144 and the exposed end of the corresponding one of the base magnets (magnet 140) is substantially flush with the base's top flat surface 128. With such configuration, the holder may be disassembled by pivoting the cover 126 with respect to the base 124 about an axis y common to the magnets 146, 148 (represented by the pivot arrow 186). By such pivoting, the magnets 140, 142 are laterally moved apart from each other, eliminating their magnetic attraction for each other, whereupon the cover may be lifted from the base against the bias of the magnets 146, 148.

The fourth holder embodiment, shown in FIG. 27, is similar to the holder embodiment 120 except that the magnets 146, 148 and their blind bores 156, 152 are eliminated in the vicinity of the first transverse edges 132, 136 of the base 124 (or 124′) and cover 126. Instead, the cover 126 is pivotally secured to the base 124 (or 124′) along the cover's first transverse edge 136 and the base's first transverse edge 132. Such pivotal securement may be implemented by at least one hinge attached to such transverse edges; for example, by a flexible tape 188 adhered to and along such edges 132, 136.

The holders of the second, third and fourth embodiments may be utilized in the manner shown in FIG. 13, for being retained by the support 70.

Thus, there has been described preferred embodiments of a protective display holder for flat items, utilizing magnets to releasably hold the cover to the base. Other embodiments of the present invention, and variations of the embodiment described herein, may be developed without departing from the essential characteristics thereof. For example, although the magnets are positioned adjacent to the transverse edges of the base and cover in the preferred embodiments, other configurations including magnets positioned adjacent to the lateral edges of the base and cover are included within the scope of the invention. Accordingly, the invention should be limited only by the scope of the claims listed below.

I claim:

1. A protective display holder for a flat item having thickness and peripheral dimensions, the holder comprising the combination of:
a substantially rigid base having a first edge and an opposite second edge, said base including a flat top surface and a recess from said top surface for receiving the flat item;
a substantially rigid cover having a first edge and an opposite second edge, said cover including a flat bottom surface;
retaining means adjacent to said first edge of said base and to said first edge of said cover for releasably retaining said bottom surface to said top surface in the vicinity of said first edges;
a first magnetic member affixed to said base adjacent to said second edge thereof; and
a second magnetic member affixed to said cover adjacent to said second edge thereof, said first and second magnetic members magnetically attracted to each other for urging said bottom surface of said cover against said top surface of said base in the vicinity of said second edges.

2. The holder according to claim 1, wherein:
at least one of said cover and said base is transparent.

3. The holder according to claim 1, wherein:
said recess has depth and peripheral dimensions equal to or greater than the respective thickness and peripheral dimensions of the flat item.

4. The holder according to claim 1, wherein:
one of said first and second magnetic members comprises a magnet.

5. The holder according to claim 4, wherein:
the other of said first and second magnetic members comprises a magnet.

6. The holder according to claim 1, wherein said retaining means includes:
a wall along said first edge of said base, said wall including at least one aperture; and
at least one projection along said first edge of said cover for being received by said at least one aperture.

7. The holder according to claim 1, wherein said retaining means includes:
a third magnetic member affixed to said base adjacent to said first edge thereof; and
a fourth magnetic member affixed to said cover adjacent to said first edge thereof, said third and fourth magnetic members magnetically attracted to each other for urging said bottom surface of said cover against said top surface of said base in the vicinity of said first edges.

8. The holder according to claim 7,
wherein:
said fourth magnetic member includes an end portion projecting from said bottom of said cover;
said third magnetic member is recessed from said top surface of said base; and
further including:
an indentation is said top surface aligned with said third magnetic member for receiving said end portion of said second magnetic member.

9. The holder according to claim 8,
wherein:
said second magnetic member includes an end portion projecting from said bottom surface of said cover;
said first magnetic member is recessed from said top surface of said base; and
further including:
an indentation is said top surface aligned with said first magnetic member for receiving said end portion of said second magnetic member.

10. The holder according to claim 1, wherein said retaining means includes:
a hinge pivotally securing said base and said cover along said first edges.

11. The holder according to claim 10, wherein:
said hinge comprises a flexible tape affixed to said first edge of said base and to said first edge of said cover.

12. The holder according to claim 1,
wherein:
one of said first and second magnetic members includes an end portion projecting from a corresponding one of said top and bottom surfaces;
the other of said first and second magnetic members is recessed from a corresponding one of said top and bottom surfaces; and
further including:
an indentation in the other of said top and bottom surfaces aligned with said other of said first and second magnetic members for receiving said end portion of said one of said first and second magnetic members.

13. The holder according to claim 1,
wherein:
said second magnetic member includes an end portion projecting from said bottom surface of said cover;
said first magnetic member is recessed from said top surface of said base; and
further including:
an indentation in said top surface aligned with said first magnetic member for receiving said end portion of said second magnetic member.

14. The holder according to claim 1, including:
at least one protrusion on one of said top and bottom surfaces in the vicinity of said second edge thereof; and
at least one indentation in the other of said top and bottom surfaces for receiving said at least one protrusion when said first magnetic member is in registration with said second magnetic member.

15. The holder according to claim 1, including:
a raised collar on one of said top and bottom surfaces about a corresponding one of said first and second magnetic members; and
an indentation in from the other of said top and bottom surfaces about a corresponding one of said first and second magnetic members for matingly receiving said collar.

16. The holder according to claim 15, wherein:
the configuration of each of said collar and said indentation is an oval with its major diameter parallel to said second edge corresponding thereto.

17. The holder according to claim 1, including:
a raised collar on said top surface of said base about said first magnet; and
an indentation in said bottom surface of said cover about said second magnetic member for matingly receiving said collar.

18. The holder according to claim 17, wherein:
each of said collar and said indentation describes an oval with its major diameter parallel to said second edges.

19. The holder according to claim 18, including:
a finger notch along at least one of said second edges.

20. The holder according to claim 1, wherein said base comprises:
a first flat panel including a bore through a surface thereof for affixing said first magnetic member; and
a second flat panel affixed to said surface of said first panel, said second panel having thickness equal to the depth of said recess and an opening therethrough of peripheral dimensions equal to the peripheral dimensions of said recess, said second panel including an aperture therethrough aligned with said bore in said first panel.

21. The holder according to claim 7, wherein said base comprises:
a first flat panel including bores through a surface thereof for respectively affixing said first and third magnetic members; and
a second flat panel affixed to said surface of said first flat panel, said second panel having thickness equal to the depth of said recess and an opening therethrough of peripheral dimensions equal to the peripheral dimensions of said recess, said second panel including apertures therethrough respectively aligned with said bores in said first panel.

22. The holder according to claim 21, wherein:
said cover and said first flat panel are transparent.

23. The holder according to claim 22, wherein:
said second flat panel is opaque.

24. A protective display holder for a flat item having thickness and peripheral dimensions, the holder comprising the combination of:
a substantially rigid base having a first edge and an opposite second edge, said base including a flat top surface and a recess from said top surface for receiving the flat item;
a substantially rigid cover having a first edge and an opposite second edge, said cover including a flat bottom surface;
a first magnetic member affixed to said base adjacent to said second edge thereof, and a second magnetic member affixed to said cover adjacent to said second edge thereof, said first and second magnetic members magnetically attracted to each other for urging said bottom surface of said cover against said top surface of said base in the vicinity of said second edges; and
a third magnetic member affixed to said base adjacent to said first edge thereof, and a fourth magnetic member affixed to said cover adjacent to said first edge thereof, said third and fourth magnetic members magnetically attracted to each other for urging said bottom surface of said cover against said top surface of said base in the vicinity of said first edges.

25. The holder according to claim 24,
wherein:
one of said third and fourth magnetic members includes an end portion projecting from a corresponding one of said top and bottom surfaces;
the other of said third and fourth magnetic members is recessed from a corresponding one of said top and bottom surfaces; and
further including:
an indentation in the other of said top and bottom surfaces aligned with said other of said third and fourth magnetic members for receiving said end portion of said one of said third and fourth magnetic members.

26. The holder according to claim 25,
wherein:
one of said first and second magnetic members includes an end portion projecting from a corresponding one of said top and bottom surfaces;
the other of said first and second magnetic members is recessed from a corresponding one of said top and bottom surfaces; and
further including:
an indentation in the other of said top and bottom surfaces aligned with said other of said first and second magnetic members for receiving said end portion of said one of said first and second magnetic members.

27. The holder according to claim 24, wherein:
at least one of said first and second magnetic members is a magnet; and
at least one of said third and fourth magnetic members is a magnet.

28. The holder according to claim 24,
wherein:
said fourth magnetic member includes an end portion projecting from said bottom of said cover;
said third magnetic member is recessed from said top surface of said base; and
further including:
an indentation in said top surface aligned with said third magnetic member for receiving said end portion of said fourth magnetic member.

29. The holder according to claim 28, wherein:
said second magnetic member includes an end surface substantially flush with the bottom surface of said cover; and
said first magnetic member includes an end surface substantially flush with the top surface of said base.

30. The holder according to claim 28,
wherein:
said second magnetic member includes an end portion projecting from said bottom surface of said cover;
said first magnetic member is recessed from said top surface of said base; and
further including:
an indentation in said top surface aligned with said first magnetic member for receiving said end portion of said second magnetic member.

31. The holder according to claim 30, wherein:
said recess has depth and peripheral dimensions equal to or greater than the respective thickness and peripheral dimensions of the flat item.

32. The holder according to claim 30, including:
a finger notch along at least one of said second edges.

33. The holder according to claim 30, wherein:
at least one of said first and second magnetic members is a magnet; and
at least one of said third and fourth magnetic members is a magnet.

34. The holder according to claim 30, wherein:
each of said magnetic members is a magnet.

35. The holder according to claim 30, wherein said base comprises:
a first flat panel including bores through a surface thereof for respectively affixing said first and third magnetic members; and
a second flat panel affixed to said surface of said first flat panel, said second panel having thickness equal to the depth of said recess and an opening therethrough of peripheral dimensions equal to the peripheral dimensions of said recess, said second panel including apertures therethrough respectively aligned with said bores in said first panel and for respectively receiving said end portions of said second and fourth magnetic members affixed to said cover.

36. The holder according to claim 35, wherein:
said cover and said first flat panel are transparent.

37. The holder according to claim 36, wherein:
said second flat panel is opaque.

38. A protective display holder for a flat item having thickness and peripheral dimensions, the holder comprising the combination of:
a substantially rigid base having a first edge and an opposite second edge, said base including a flat top surface and a recess from said top surface for receiving the flat item;
a substantially rigid cover having a first edge and an opposite second edge, said cover including a flat bottom surface;
a wall along said first edge of said base, said wall including at least one aperture;
at least one projection along said first edge of said cover for being received by said at least one aperture; and
a first magnetic member affixed to said base adjacent to said second edge thereof, and a second magnetic member affixed to said cover adjacent to said second edge thereof, said first and second magnetic members magnetically attracted to each other for urging said bottom surface of said cover against said top surface of said base in the vicinity of said second edges.

39. The holder according to claim 38, wherein:
said recess has depth and peripheral dimensions equal to or greater than the respective thickness and peripheral dimensions of the flat item.

40. The holder according to claim 38, wherein:
at least one of said cover and said base is transparent.

41. The holder according to claim 38, including:
at least one protrusion on one of said top and bottom surfaces in the vicinity of said second edge thereof; and
at least one indentation in the other of said top and bottom surfaces for receiving said at least one protrusion when said first magnetic member is in registration with said second magnetic member.

42. The holder according to claim 38, including:
a raised collar on one of said top and bottom surfaces about a corresponding one of said first and second magnetic members; and
an indentation in from the other of said top and bottom surfaces about a corresponding one of said first and second magnetic members for matingly receiving said collar.

43. The holder according to claim 42, wherein:
the configuration of each of said collar and said indentation is an oval with its major diameter parallel to said second edge corresponding thereto.

44. The holder according to claim 38, including:
a raised collar on said top surface of said base about said first magnet; and
an indentation in said bottom surface of said cover about said second magnetic member for matingly receiving said collar.

45. The holder according to claim 44, wherein:
each of said collar and said indentation describes an oval with its major diameter parallel to said second edges.

46. The holder according to claim 45, including:
a finger notch along at least one of said second edges.

47. A protective display holder for a flat item having thickness and peripheral dimensions, the holder comprising the combination of:
a substantially rigid base having a first edge and an opposite second edge, said base including a flat top surface and a recess from said top surface for receiving the flat item;
a substantially rigid cover having a first edge and an opposite second edge, said cover including a flat bottom surface;
a hinge pivotally securing said base and said cover along said first edges; and
a first magnetic member affixed to said base adjacent to said second edge thereof, and a second magnetic member affixed to said cover adjacent to said second edge thereof, said first and second magnetic members magnetically attracted to each other for urging said bottom surface of said cover against said top surface of said base in the vicinity of said second edges.

48. The holder according to claim 47, wherein:
said hinge comprises a flexible tape affixed to said first edge of said base and to said first edge of said cover.

49. A protective display holder for a flat item having thickness and peripheral dimensions, the holder comprising the combination of:
a substantially rigid base having a first edge and an opposite second edge, said base including a flat top surface and a recess from said top surface for receiving the flat item;
a substantially rigid cover having a first edge and an opposite second edge, said cover including a flat bottom surface facing said top surface and said recess, said bottom surface releasably retained to said top surface in the vicinity of said first edges;
a first magnetic member affixed to said base adjacent to said second edge thereof; and
a second magnetic member affixed to said cover adjacent to said second edge thereof, said first and second magnetic members magnetically attracted to each other for urging said bottom surface of said cover against said top surface of said base in the vicinity of said second edges.

50. The holder according to claim 49, wherein:
said recess has depth and peripheral dimensions equal to or greater than the respective thickness and peripheral dimensions of the flat item.

51. The holder according to claim 49, wherein:
at least one of said cover and said base is transparent.

52. The holder according to claim 49, wherein:
one of said first and second magnetic members comprises a magnet.

53. The holder according to claim 52, wherein:
the other of said first and said second magnetic members comprises a magnet.

54. The holder according to claim 49, including:
at least one protrusion on one of said top and bottom surfaces in the vicinity of said second edge thereof; and
at least one indentation in the other of said top and bottom surfaces releasably receiving said at least one protrusion.

55. The holder according to claim 49, including:
a raised collar on one of said top and bottom surfaces about a corresponding one of said first and second magnetic members; and
an indentation in from the other of said top and bottom surfaces about a corresponding one of said first and second magnetic members, said indentation matingly receiving said collar.

56. The holder according to claim 55, wherein:
the configuration of each of said collar and said indentation is an oval with its major diameter parallel to said second edge corresponding thereto.

57. The holder according to claim 49, including:
a raised collar on said top surface of said base about said first magnet; and
an indentation in said bottom surface of said cover about said second magnetic member, said indentation matingly receiving said collar.

58. The holder according to claim 57, wherein:
each of said collar and said indentation describes an oval with its major diameter parallel to said second edges.

59. The holder according to claim 49, including:
a finger notch along at least one of said second edges.

60. The holder according to claim 49,
wherein:
one of said first and second magnetic members includes an end portion projecting from a corresponding one of said top and bottom surfaces;
the other of said first and second magnetic members is recessed from a corresponding one of said top and bottom surfaces; and
further including:
an indentation in the other of said top and bottom surfaces aligned with said other of said first and second magnetic members, said indentation receiving said end portion of said one of said first and second magnetic members.

61. The holder according to claim 49,
wherein:
said second magnetic member includes an end portion projecting from said bottom surface of said cover;
said first magnetic member is recessed from said top surface of said base; and
further including:
an indentation in said top surface aligned with said first magnetic member, said indentation receiving said end portion of said second magnetic member.

62. The holder according to claim 49, wherein said base comprises:
a first flat panel including a bore through a surface thereof for affixing said first magnetic member; and
a second flat panel affixed to said surface of said first panel, said second panel having thickness equal to the depth of said recess and an opening therethrough of peripheral dimensions equal to the peripheral dimensions of said recess, said second panel including an aperture therethrough aligned with said bore in said first panel.

63. A protective display holder for a flat item having thickness and peripheral dimensions, the holder comprising the combination of:
a substantially rigid base having a flat top surface and a recess from said top surface, said recess having depth and peripheral dimensions equal to or greater than the respective thickness and peripheral dimensions of the flat item;
a substantially rigid cover having a flat bottom surface; and
at least one magnetic member affixed to said base and at least one magnetic member affixed to said cover and magnetically attracted to said at least one magnetic member affixed to said base for urging said bottom surface of said cover against said top surface of said base.

64. The holder according to claim 63, wherein:
said at least one magnetic member affixed to said base comprises at least one magnet.

65. The holder according to claim 63, wherein:
said at least one magnetic member affixed to said cover comprises at least one magnet.

66. The holder according to claim 65, wherein:
said at least one magnetic member affixed to said base comprises at least one magnet.

67. The holder according to claim 63, wherein:
at least one of said cover and said base is transparent.
